(19) United States
(12) Patent Application Publication
(10) Pub. No.: US 2025/0109315 A1
(43) Pub. Date: Apr. 3, 2025

(54) SILICONE-MODIFIED POLYUREA COATING COMPOSITIONS

(71) Applicant: PPG Industries Ohio, Inc., Cleveland, OH (US)

(72) Inventors: Marc Williams, Beaver Falls, PA (US); Chandler Johnson, Valencia, PA (US); Edward R. Millero, JR., Gibsonia, PA (US); Chinming Hui, Pittsburgh, PA (US); Jiping Shao, Sewickley, PA (US); Scott Joseph Moravek, Mars, PA (US); Gobinda Saha, Pittsburgh, PA (US); Wells B. Warren, III, Sarver, PA (US)

(73) Assignee: PPG Industries Ohio, Inc., Cleveland, OH (US)

(21) Appl. No.: 18/725,280

(22) PCT Filed: Oct. 28, 2022
(86) PCT No.: PCT/US2022/078884

§ 371 Date: Jun. 28, 2024

Related U.S. Application Data
(60) Provisional application No. 63/294,871, filed on Dec. 30, 2021.

(51) Int. Cl. C09D 175/02; C08G 18/10; C08G 18/24; C08G 18/61; C09D 5/14; C09D 5/16; C09D 7/80

(52) U.S. Cl. CPC C09D 175/02; C08G 18/10; C08G 18/246; C08G 18/61; C09D 5/14; C09D 5/1675; C09D 7/80

(57) ABSTRACT

The application relates to a coating composition that combines fouling release and/or ice release performance with flexibility and durability. The coating composition comprises a polyurea component and a polysiloxane component. The polyurea component comprises an isocyanate component, an amine-functional resin and an aliphatic copolymer. The corresponding method for coating a substrate is also addressed.

### CROSS-REFERENCE TO RELATED APPLICATION

This application claims priority to U.S. Provisional Patent Application 63/294,871, filed Dec. 30, 2021, the entire disclosure of which is hereby incorporated herein by reference.

### STATEMENT REGARDING FEDERALLY SPONSORED RESEARCH OR DEVELOPMENT

This disclosure was made with Government support under Government Contract No. NCMS FY2017 Watercraft Coating 201853. The United States Government may have certain rights in aspects of this disclosure.

### FIELD

Described herein are coating compositions for applying to a substrate and methods of coating substrates.

### BACKGROUND

Outdoor structures such as wind turbines, bridges, towers, tanks, pipes, and fleet vehicles such as railcars are constantly exposed to the elements and must be designed to endure temperature extremes, wind shears, precipitation, ice adhesion, and other environmental hazards without significant damage or the need for constant maintenance, which may be time-consuming and costly. Likewise, marine structures such as ship hulls and off-shore oil rigs and wind turbines are also exposed to seawater as well as extreme weather and other environmental conditions making them susceptible to corrosion, marine fouling, abrasion, and impact. More effective treatments and coating systems are continually being sought to meet the specification demands of these industrial structures.

### SUMMARY

The present disclosure is directed to coating compositions. A coating composition may comprise a polyurea component comprising: an isocyanate component, an amine-functional resin, and an aliphatic copolymer; and a polysiloxane component. The present disclosure is further directed to methods for coating a substrate. A method may comprise applying to at least a portion of the substrate a coating composition described herein.

### DETAILED DESCRIPTION

Provided herein are coating compositions and methods that can be applied to substrates for improved fouling release and/or ice release performance. The present disclosure relates to coating compositions that can combine fouling release and ice release performance with flexibility and durability. In some cases, the coatings described herein can form quickly and may significantly reduce the amount of time required to recoat a substrate, which can result in less down time and quicker return to service times for products.

Many conventional fouling/ice release coatings are soft and provide little protection from abrasion and impact. Many conventional epoxy coatings may provide some protection from abrasion and impact, but fail to prevent or minimize marine fouling release and ice adhesion. The coating compositions described herein may demonstrate extended durability and desirable properties such as high contact angle (water and diiodomethane), low ice adhesion strength, high marine fouling release, high abrasion resistance, and high Young's modulus.

Described herein are coating compositions that may comprise a polyurea component and a polysiloxane component, where an equivalent weight ratio of the isocyanate component to the amine-functional resin ranges from 1.01:1 to 1.4:1. The polyurea component may comprise an isocyanate component, an amine-functional resin, and an aliphatic copolymer. The amine-functional resin may comprise a difunctional amine, a triamine, and an aliphatic diamine chain extender. The aliphatic copolymer component may comprise a silicone copolymer. The isocyanate component may comprise a prepolymer formed from isophorone diisocyanate and polyetherdiamine.

The coating composition described herein may comprise an amine-functional resin in an amount of from 16 to 43 wt. % (e.g., from 20 to 40%, from 18 to 32%, or from 30 to 35%). The composition may include 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42% or 43% of an amine-functional resin. All percentages of amine-functional resin are expressed in wt. % based on the total solid weight of the composition. In some cases, the amine-functional resin may comprise a di-functional amine, a triamine, an aliphatic diamine chain extender, or combinations thereof.

In some cases, the coating composition may comprise an equivalent weight ratio of the isocyanate component to the amine-functional resin of from 1.01:1 to 1.4:1 (e.g., 1.08:1, 1.13:1 or 1.25:1). The composition may comprise an equivalent weight ratio of the isocyanate component to the amine-functional resin of 1.01:1, 1.02:1, 1.04:1, 1.05:1, 1.06:1, 1.08:1, 1.1:1, 1.12:1, 1.14:1, 1.15:1, 1.16:1, 1.18:1, 1.2:1, 1.22:1, 1.24:1, 1.25:1, 1.26:1, 1.28:1, 1.3:1, 1.32:1, 1.34:1, 1.35:1, 1.36:1, 1.38:1, or 1.4:1.

The coating composition described herein may comprise a di-functional amine in an amount of from 8 to 25 wt. % (e.g., from 10 to 22%, from 12 to 18%, or from 15 to 20%). The composition may include 8%, 9%, 10%, 11%, 12%, 13%, 14%, 15%, 16%, 17%, 18%, 19%, 20%, 21%, 22%, 23%, 24%, or 25% of a di-functional amine. All percentages of a di-functional amine are expressed in wt. % based on the total solid weight of the composition. In some cases, the di-functional amine may comprise an aspartic acid ester.

The coating composition described herein may comprise a triamine in an amount of from 5 to 15 wt. % (e.g., from 5 to 12%, from 10 to 15%, or from 8 to 14%). The composition may include 5%, 6%, 7%, 8%, 9%, 10%, 11%, 12%, 13%, 14%, or 15% of a triamine. All percentages of triamine are expressed in wt. % based on the total solid weight of the composition. In some cases, the triamine may comprise polyetheramine.

The coating composition described herein may comprise an aliphatic diamine chain extender in an amount of from 3.6 to 12 wt. % (e.g., from 4 to 10%, from 6 to 9.5%, or from 8.5 to 9%). The composition may include 3.6%, 4%, 4.5%, 5%, 5.5%, 6%, 6.5%, 7%, 7.5%, 8%, 8.5%, 9%, 9.5%, 10%, 10.5%, 11%, 11.5%, or 12% of an aliphatic diamine chain extender. All percentages of aliphatic diamine chain extender are expressed in wt. % based on the total solid weight of the composition. In some cases, the aliphatic diamine chain extender may comprise an ethylcyanide.

The coating composition described herein may comprise a polysiloxane component in an amount of up to 60 wt. % (e.g., up to 15%, up to 30%, or up to 50%). The composition may include 1%, 5%, 10%, 15%, 20%, 25%, 30%, 35%, 40%, 45%, 50%, 55%, or 60% polysiloxane component. All percentages of polysiloxane component are expressed in wt. % based on the total solid weight of the composition. The polysiloxane component may comprise an amine functional silicone, a silicone polyether copolymer, a phenyl silicone, or combinations thereof. The amine functional silicone fluid may comprise a mono-, di-, or tri-functional amine. Optionally, the polysiloxane component may comprise polydimethylsiloxane, phenylmethyl polysiloxane, polyphenylmethyldimethylsiloxane, or combinations thereof.

The polyurea component may further comprise a tin compound. In some examples, the tin compound may comprise an organotin compound. In some examples, the tin compound may comprise less than 1 wt. % of the composition based on total solid weight of the composition (e.g., up to 0.8%, up to 0.5%, or up to 0.2%). The composition may include 0.1%, 0.2%, 0.3%, 0.4%, 0.5%, 0.6%, 0.7%, 0.8%, 0.9%, or up to 1% of the tin compound. All percentages of the tin compound are expressed in wt. % based on the total solid weight of the composition. Optionally, the tin compound may comprise dibutyltin dilaurate (DBDL) and/or dibutyltin diacetate (DBDA). In some examples, the composition may be free of a tin or organotin compound.

The coating composition described herein may further comprise a biocide. The biocide may limit the growth of bacteria on a coated substrate and/or destroy bacteria on a substrate. In some examples, the biocide may comprise a silver- or copper-containing compound. In some examples, the composition may be free of a biocide.

The coating composition may further comprise additives in an amount up to 30 wt. % (e.g., from 1 to 3%, from 2 to 10%, or from 5 to 25%). The composition may include 1%, 2%, 4%, 5%, 6%, 8%, 10%, 12%, 14%, 15%, 16%, 18%, 20%, 22%, 24%, 25%, 26%, 28%, or 30% additives. All percentages of additives are expressed in wt. % based on the total solid weight of the composition. The additives may comprise a wetting agent, a dispersing agent, a UV absorber, a hindered amine light stabilizer (HALS), an organic clay derivative, fumed silica, pigments, or combinations thereof.

The coating compositions described herein may comprise a polyurea component and a polysiloxane component, where an equivalent weight ratio of the isocyanate component to the amine-functional resin ranges from 1.01:1 to 1.2:1. In some examples, the polysiloxane component may comprise up to 60 wt. % of the composition. The polyurea component may comprise an isocyanate component, an amine-functional resin, and an aliphatic copolymer. In some examples, the composition may comprise from 16 to 43 wt. % amine-functional resin. The amine-functional resin may comprise a di-functional amine, a triamine, and an aliphatic diamine chain extender. In some examples, the amine-functional resin may comprise from 8 to 25 wt. % di-functional amine, from 5 to 15 wt. % triamine, and from 3.6 to 12 wt. % aliphatic diamine chain extender. The aliphatic copolymer component may comprise a silicone copolymer. Optionally, the aliphatic copolymer component may comprise a silicone polyether copolymer. The isocyanate component may comprise a prepolymer formed from isophorone diisocyanate and polyetherdiamine.

In some examples, a coating composition may comprise a polyurea component comprising an isocyanate component, from 16 to 43 wt. % amine-functional resin, and an aliphatic copolymer; up to 60 wt. % polysiloxane component, where an equivalent weight ratio of the isocyanate component to the amine-functional resin ranges from 1.01:1 to 1.2:1, and where the amine-functional resin comprises from 8 to 25 wt. % di-functional amine, from 5 to 15 wt. % triamine, and from 3.6 to 12 wt. % aliphatic diamine chain extender. Optionally, the coating composition may further comprise an organotin compound in an amount less than 1 wt. % and/or up to 10 wt. % of an additive, the additive comprising a wetting agent, a dispersing agent, a UV absorber, a hindered amine light stabilizer (HALS), an organic clay derivative, fumed silica, pigment, biocide, or combinations thereof.

Also disclosed herein are methods for coating a substrate. Examples of suitable substrates may include metal, plastic, concrete, asphalt, wood, geotextile, a fiberglass composite, and/or carbon fiber composite. In some examples, the metal substrate may comprise iron, steel, steel alloys, galvanized metals, and/or aluminum. A method of coating a substrate may comprise applying to at least a portion of a substrate the coating composition described herein. In some examples, at least a portion of the substrate may comprise a first coating and/or a primer.

Optionally, the method may further comprise preparing at least a portion of the substrate prior to applying the coating composition. In some examples, preparing at least a portion of the substrate may comprise grit blasting, sand blasting, priming, and/or electrocoating at least a portion of the substrate. In some examples, preparing at least a portion of the substrate may comprise applying a mold release agent to at least a portion of the substrate.

The methods for applying the coating composition may comprise extrusion and/or spraying. The coating may be sprayed by air purge spray, mechanical purge spray, atomized air spray, non-atomized air spray, atomized airless spray, non-atomized airless spray, or other means known to those skilled in the art.

A substrate may comprise the coating composition described herein. Suitable substrates for use in the methods described herein include metal, plastic, concrete, asphalt, wood, geotextile, a fiberglass composite, and/or carbon fiber composite. Suitable metal substrates such as ferrous metals, aluminum, aluminum alloys, and other metal and alloy substrates. The ferrous metal substrates used in the practice of the present disclosure may include iron, steel, and alloys thereof. Non-limiting examples of useful steel materials include hot and cold rolled steel, galvanized (zinc coated) steel, electrogalvanized steel, stainless steel, pickled steel, and combinations thereof. Combinations or composites of ferrous and non-ferrous metals can also be used.

The substrate can comprise a vehicle, a structure, or an industrial protective structure, such as an electrical box enclosure, transformer housing, motor control enclosure, railcar container, tunnel, bridge, oil or gas industry component, such as, platforms, pipes, tanks, vessels, and their supports, marine components, automotive body parts, aerospace components, pipelines, storage tanks, wind turbine components, roofing structure components, pilings, abutments, seawalls, and general purpose steel specimen. An article may comprise a substrate comprising the coating composition described herein.

“Structure” as used herein refers to a building, bridge, oil rig, oil platform, water tower, power line tower, support structures, wind turbines, walls, piers, docks, levees, dams, shipping containers, trailers, and any metal structure that is exposed to a corrosive environment. “Vehicle” refers to in its broadest sense all types of vehicles, such as but not limited to cars, trucks, buses, tractors, harvesters, heavy duty equipment, vans, golf carts, motorcycles, bicycles, railcars, airplanes, helicopters, boats of all sizes and the like.

In some examples, a coated substrate may have desirable fouling release properties. Biofouling, the attachment of marine organisms on ship hulls, can be disadvantageous for marine ships and vessels. The attached marine organisms can increase the roughness of the surface of a vessel, which can increase the frictional drag, and impede movement of the vessel. The organisms can damage ship hulls and lead to increased rates of corrosion of the ship hulls. In some examples, a coated substrate may demonstrate a maximum barnacle adhesion force of 0.2 MPa when subjected to a BARNACLE REMOVAL RELEASE TEST, as described below. For example, the maximum barnacle adhesion force may be 0.1 MPa, 0.15 MPa, or 0.2 MPa. In a BARNACLE REMOVAL RELEASE TEST, a substrate may be exposed to conditions favorable to barnacle adhesion for a specified time period, such as 30 days. The force required to remove the barnacle may be recorded as a maximum average load force. The BARNACLE REMOVAL RELEASE TEST may include a barnacle breakage test to confirm that removal force recorded was not due to a failure point of the barnacle instead of the adhesion force of the barnacle to the substrate.

In some examples, a coated substrate may have desirable ice release properties. Ice buildup on surfaces such as wind turbine blades may disrupt performance and can cause turbine overloads and/or rotor imbalance. Ice throws or large sections of ice falling from a structure present a danger to the immediate area. In some examples, a coated substrate may demonstrate a maximum average load force of 400 N when subjected to an ICE ADHESION TEST, described below. For example, the maximum average load force may be 250 N, 275 N, 300 N, 325 N, 350 N, 375 N, or 400 N.

Coating on substrates can be damaged by abrasion during manufacturing and service. In some examples, the coatings described herein may be durable and a coated substrate may resist abrasion. A coated substrate may have a loss of less than 60 mg to the coating for abrasion resistance as measured by ASTM D4060-14. For example, the coating loss may be less than 20 mg, 35 mg, 30 mg, 35 mg, 40 mg, 45 mg, 50 mg, 55 mg, or 60 mg for abrasion resistance as measured by ASTM D4060-14.

In some examples, a coated substrate may have desirable marine biofouling removal properties. A biofilm, a thin sheet of bacteria, can form on the surface of a marine vessel. The biofilm can lead to material deterioration such as microbial-influenced corrosion of ferrous and nonferrous metals, increased drag, and lost efficiency from the biological fouling activities. In some examples, a coated substrate may demonstrate a minimum average removal of at least 30% for Cellulophaga lytica (C. lytica) and at least 50% for Navicula incerta (N. incerta) when subjected to MICROORGANISM REMOVAL TEST with a 20 psi water jet, as described below.

As used herein, unless otherwise expressly specified, all numbers such as those expressing values, ranges, amounts or percentages may be read as if prefaced by the word “about”, even if the term does not expressly appear. Any numerical range recited herein is intended to include all subranges subsumed therein. Plural encompasses singular and vice versa. For example, while the disclosure has been described in terms of “an” amine-functional resin, a mixture of such resins can be used. Also, as used herein, the term “polymer” is meant to refer to prepolymers, oligomers and both homopolymers and copolymers; the prefix “poly” refers to two or more. Similarly, as used herein, the terms “on”, “applied on/over”, “formed on/over”, “deposited on/over”, “overlay” and “provided on/over” a surface mean applied, formed, deposited, overlay, or provided, respectively, on but not necessarily in contact with the surface. For example, a coating layer “formed over” a substrate does not preclude the presence of other coating layers of the same or different composition located between the formed coating layer and the substrate.

Notwithstanding that the numerical ranges and parameters setting forth the broad scope of the disclosure are approximations, numerical values set forth in the specific examples are reported as precisely as possible. Any numerical value, however, inherently contains certain errors necessarily resulting from the standard variation found in their respective testing measurements. When ranges are given, any endpoints of those ranges and/or numbers within those ranges can be combined within the scope of the present disclosure.

As used herein, the meaning of “a,” “an,” and “the” includes singular and plural references unless the context clearly dictates otherwise.

As used herein, the terms “comprising,” “having,” “including,” and “containing” are to be construed as open-ended terms (i.e., meaning “including, but not limited to”) unless otherwise noted and do not limit the disclosure claimed to exclude any variants or additions. Although the disclosure has been described in terms of “comprising”, “consisting essentially of” or “consisting of” are also within the scope of the present disclosure. In this context, “consisting essentially of” means that any additional components will not materially affect the viscosity or other properties of the composition.

Each of the characteristics and examples described above and below, and combinations thereof, may be said to be encompassed by the present disclosure.

The following working examples are intended to further describe the disclosure. It is understood that the disclosure described in this specification is not necessarily limited to the examples described in this section. Components that are mentioned elsewhere in the specification as suitable alternative materials for use in the disclosure, but which are not demonstrated in the working examples below, are expected to provide results comparable to their demonstrated counterparts.

### EXAMPLES

Notwithstanding that the numerical ranges and parameters setting forth the broad scope of the disclosure are approximations, numerical values set forth in the specific examples are reported as precisely as possible. Any numerical value, however, inherently contains certain errors necessarily resulting from the standard variation found in their respective testing measurements.

Comparative and Working Examples of ice release and fouling release coating compositions were prepared and evaluated for performance. The compositions evaluated are listed in Table 1. Examples 1 and 2 are Comparative Examples. Examples 3-4 are Working Examples of the coating composition as described herein.

TABLE 1

| | Ex. 1 | Ex. 2 | Ex. 3 | Ex. 4 |
|---|---|---|---|---|
| B-Pack: | | | | |
| Amine-functional resin | 42.79 | 44.04 | 30.83 | 27.16 |
| Silicone copolymer | 0 | 0 | 0 | 5.63 |
| DBDL | 0.13 | 0.13 | 0.09 | 0.08 |
| Other additives | 7.57 | 0 | 5.45 | 4.8 |
| Amine functional silicone | 0 | 3.15 | 9.03 | 7.96 |
| Polysiloxane | 0 | 0 | 4.52 | 3.98 |
| A-Pack: | | | | |
| Isocyanate functional prepolymer #1 | 49.51 | 52.68 | 35.04 | 0 |
| Isocyanate functional prepolymer #2 | 0 | 0 | 0 | 50.39 |
| Silicone copolymer | 0 | 0 | 15.02 | 0 |

Isocyanate functional prepolymer #1 was synthesized according to the process described in U.S. Pat. No. 8,691,929 (Example 1). Isocyanate functional prepolymer #2 was synthesized according to the process described in U.S. Pat. No. 8,691,929 (Example 2). Other additives included: Bentone 34, a clay derivative available from Akzo Nobel Chemicals (Amsterdam, Netherlands); BYK-9077, a solvent-free wetting and dispersing additive available from BYK Additives and Instruments (Wesel, Germany), a pigment such as TiO₂; hydrophilic fumed silica; and an UV absorber.

The B-pack (amine) samples were prepared by first combining the 50% of the amine-functional resin with the BYK-9077 dispersant, UV absorber, and DBDL, where applicable. Under agitation, the pigment, where applicable, was added to the resin blend and ground with a Cowles blade under high shear for 30 min. Upon completion of the grind phase, the remaining 50% of the amine-functional resin was added along with the amine functional silicone and polysiloxane component, where applicable, under low shear and mixed for 10 min to complete the B-pack formulation. Samples were shaken for 10 min prior to all application work to ensure a homogenous sample.

The A-pack (isocyanate) was prepared by combining isocyanate functional prepolymer #1 with 0-30% of total formula weight of silicone copolymer, where applicable. The samples were agitated and mixed using an impeller blade under a nitrogen-rich environment. An alternate A-pack was also used that includes an isocyanate functional prepolymer #2 synthesized through the process described in U.S. Pat. No. 8,691,929 (Example 2).

Substrates were coated via extrusion of the coating. Wet samples were first loaded in 50 mL, 1:1, 2-component cartridges (Nordson TAH 50 mL cartridge) and capped with O-ring pistons (Nordson EFD EPDM O-ring piston tall). Application was conducted using a pneumatic gun (Cox A25 Dual Component 50 mL Pneumatic Cartridge Gun) set between 20-30 psi application pressure with a 6 inch static mixing tip (Nordson 7701488). Samples were extruded and then quickly drawn down to approx. 20 mil. Coating thickness was controlled using shims while drawing down. Ferrous substrates (CRS steel, smooth finish Q-panel Stock #QD-412, E-coated CRS-ACT Prod. #26241) were prepared on a magnetic board to hold samples in place and maintain a flat working surface. Non-ferrous substrates (4″×8″ pre-primed Aluminum: Q-panel Stock #AQ-48) were prepared using a vacuum drawdown plate. Samples for ice release were coated on both sides of the substrate with 1-day allowed between applications. Samples were cured for 7 days before any testing took place.

Coatings were evaluated for surface free energy, water and diiodomethane (DM) contact angles, ice release force, abrasion resistance, and fouling release properties.

To evaluate the effectiveness of formulation changes on ice adhesion an ICE ADHESION TEST was developed. The test method used was described in US Army Corps of Engineers Engineer Research and Development Center document number ERDC/CRREL TR-06-11, which is incorporated herein by reference. The fixture design as described therein was modified to interface with existing testing equipment and to receive test panels of approximately 0.032″ thick. Generally, the procedure was as follows: A 4″ wide test panel was coated on both sides with the desired coating(s). After the appropriate cure time, five 1×4″ strips were cut from the test panel. The test strips were taped in place in the center of the test fixture such that the fixture could be filled with water one inch deep. Chilled water was used to fill the test fixtures ensuring that both sides of the coated panel are in contact with one inch of water. The entire test fixture was placed in a −20° C. freezer overnight. Then the test fixture was transferred to a tensile tester (e.g. INSTRON 5567) equipped with an environmental chamber also set to −20° C. The test fixture was mounted such that the fixed end of the tensile tester is connected to the test fixture and the movable jaw is connected to the test panel. This testing setup creates a relative motion between the test strip and the ice that was formed from the water. The tape that held the test strip and water in place was removed and then, using a constant extension rate, the maximum force required to remove the panel from the ice was recorded. Typically, five specimens of each coating variation were tested and an average maximum load reported.

To evaluate the effectiveness of formulation changes on fouling release a BARNACLE REMOVAL RELEASE TEST was developed. The test method used was described in Stafslien, Shane, et al., “An improved laboratory reattachment method for the rapid assessment of adult barnacle adhesion strength to fouling-release marine coatings,” J. Coat. Technol. Res., April 2012.

To evaluate the effectiveness of formulation changes on microbial release a MICROORGANISM REMOVAL TEST using a 20 psi water jet was developed. The test method used was described in Stafslien, Shane, et al., “Combinatorial materials research applied to the development of new surface coatings VI: An automated spinning water jet apparatus for the high-throughput characterization of fouling-release marine coatings,” Am. Inst. Physics, Rev. Scientific Instruments, 78, 072204, 2007, and Casse, Franck, et al., “Combinatorial materials research applied to the development of new surface coatings V. Application of a spinning water-jet for the semi-high throughput assessment of the attachment strength of marine fouling algae,” Biofouling, 23:2, 121, 2007.

Abrasion resistance was collected using a Taber 5150 instrument based on ASTM D4060-14 with CS-17 abrasive disks for 1000 cycles with 1 kg weights at 60 RPM with vacuum. The abrasive disks were resurfaced with the S-11 abrasive disk for 50 cycles after every 500 test cycles. Abrasion resistance was recorded as weight loss (mg) of the coating after 1000 test cycles. Surface free energy and contact angles were collected by using a Kruss DSA 100 instrument via ASTM 7490-13.

The properties for the test panels are provided in Table 2.

TABLE 2

| Property | Ex. 1 | Ex. 2 | Ex. 3 | Ex. 4 |
|---|---|---|---|---|
| Surface Free Energy | 42.63 | 14.42 | 30.11 | 31.36 |
| Water Contact Angle | 73.91 | 106.9 | 93.85 | 21.35 |
| DM Contact Angle | 47.04 | 89.8 | 60.1 | 74.17 |
| Ice Release Force (N) | 773.29 | 310.97 | 298.91 | 47.86 |
| Abrasion Resistance (mg loss) | 72 | 47 | 21.7 | 39 |
| Microorganism removal | 45 | 38 | 82 | |
| (C. lytica)(%) | | | | |
| Microorganism removal | 92 | 78 | 96 | |
| (N. incerta)(%) | | | | |
| Barnacle adhesion force (MPa) | 0.2 | 0.34 | 0.09 | |

### Illustrative Embodiments of Suitable Compositions and Methods

As used below, any reference to compositions, articles, or methods is understood as a reference to each of those compositions, articles, or methods disjunctively (e.g., “Illustrative embodiment 1-4 is understood as illustrative embodiment 1, 2, 3, or 4.”).

Illustrative embodiment 1 is a coating composition comprising: a polyurea component comprising an isocyanate component, an amine-functional resin, and an aliphatic copolymer; and a polysiloxane component.

Illustrative embodiment 2 is the coating composition of any preceding or subsequent illustrative embodiment, wherein an equivalent weight ratio of the isocyanate component to the amine-functional resin ranges from 1.01:1 to 1.4:1.

Illustrative embodiment 3 is the coating composition of any preceding or subsequent illustrative embodiment, wherein the amine-functional resin ranges from 16 to 43 wt. %.

Illustrative embodiment 4 is the coating composition of any preceding or subsequent illustrative embodiment, wherein the aliphatic copolymer component comprises a silicone copolymer.

Illustrative embodiment 5 is the coating composition of any preceding or subsequent illustrative embodiment, wherein the aliphatic copolymer component comprises a silicone polyether copolymer.

Illustrative embodiment 6 is the coating composition of any preceding or subsequent illustrative embodiment, wherein the isocyanate component comprises a prepolymer formed from isophorone diisocyanate and polyetherdiamine.

Illustrative embodiment 7 is the coating composition of any preceding or subsequent illustrative embodiment, wherein the amine-functional resin comprises a di-functional amine, a triamine, an aliphatic diamine chain extender, or combinations thereof.

Illustrative embodiment 8 is the coating composition of any preceding or subsequent illustrative embodiment, wherein the di-functional amine ranges from 8 to 25 wt. % based on total solid weight of the composition.

Illustrative embodiment 9 is the coating composition of any preceding or subsequent illustrative embodiment, wherein the di-functional amine comprises an aspartic acid ester.

Illustrative embodiment 10 is the coating composition of any preceding or subsequent illustrative embodiment, wherein the triamine ranges from 5 to 15 wt. % based on total solid weight of the composition.

Illustrative embodiment 11 is the coating composition of any preceding or subsequent illustrative embodiment, wherein the triamine comprises polyetheramine.

Illustrative embodiment 12 is the coating composition of any preceding or subsequent illustrative embodiment, wherein the aliphatic diamine chain extender ranges from 3.6 to 12 wt. % based on total solid weight of the composition.

Illustrative embodiment 13 is the coating composition of any preceding or subsequent illustrative embodiment, wherein the aliphatic diamine chain extender comprises an ethylcyanide.

Illustrative embodiment 14 is the coating composition of any preceding or subsequent illustrative embodiment, wherein the polysiloxane component comprises up to 60 wt. % based on total solid weight of the composition.

Illustrative embodiment 15 is the coating composition of any preceding or subsequent illustrative embodiment, wherein the polysiloxane component comprises an amine functional silicone, a silicone polyether copolymer, a phenyl silicone, or combinations thereof.

Illustrative embodiment 16 is the coating composition of any preceding or subsequent illustrative embodiment, wherein the polysiloxane component comprises a polydimethylsiloxane, phenylmethyl polysiloxane, polyphenylmethyldimethylsiloxane, or combinations thereof.

Illustrative embodiment 17 is the coating composition of any preceding or subsequent illustrative embodiment, further comprising a tin compound, wherein the tin compound optionally comprises an organotin compound.

Illustrative embodiment 18 is the coating composition of any preceding or subsequent illustrative embodiment, wherein the organotin compound comprises less than 1 wt. % of the composition based on total solid weight of the composition.

Illustrative embodiment 19 is the coating composition of any preceding or subsequent illustrative embodiment, further comprising a biocide.

Illustrative embodiment 20 is the coating composition of any preceding or subsequent illustrative embodiment, wherein the biocide comprises silver and/or copper.

Illustrative embodiment 21 is a coating composition comprising: a polyurea component comprising: an isocyanate component, 16 to 43 wt. % of an amine-functional resin, and an aliphatic copolymer; and up to 60 wt. % of a polysiloxane component, wherein an equivalent weight ratio of the isocyanate component to the amine-functional resin ranges from 1.01:1 to 1.4:1.

Illustrative embodiment 22 is the coating composition of any preceding or subsequent illustrative embodiment, wherein the amine-functional resin comprises: 8 to 25 wt. % of a di-functional amine; 5 to 15 wt. % of a triamine; and 3.6 to 12 wt. % of an aliphatic diamine chain extender.

Illustrative embodiment 23 is the coating composition of any preceding or subsequent illustrative embodiment, further comprising an organotin compound in an amount less than 1 wt. %.

Illustrative embodiment 24 is the coating composition of any preceding or subsequent illustrative embodiment, further comprising an additive in an amount up to 30 wt. %, wherein the additive comprises a wetting agent, a dispersing agent, a UV absorber, a hindered amine light stabilizer (HALS), an organic clay derivative, fumed silica, a pigment, a biocide, or combinations thereof.

Illustrative embodiment 25 is a coating composition comprising: a polyurea component comprising: an isocyanate component, 8 to 25 wt. % of a di-functional amine; 5 to 15 wt. % of a triamine; 3.6 to 12 wt. % of an aliphatic diamine chain extender; and an aliphatic copolymer; and up to 60 wt. % of a polysiloxane component, wherein an equivalent weight ratio of the isocyanate component to the total amount of di-functional amine, triamine, and aliphatic diamine chain extender ranges from 1.01:1 to 1.4:1.

Illustrative embodiment 26 is the coating composition of any preceding or subsequent illustrative embodiment, further comprising an organotin compound in an amount less than 1 wt. %.

Illustrative embodiment 27 is the coating composition of any preceding illustrative embodiment, further comprising an additive in an amount up to 10 wt. %, wherein the additive comprises a wetting agent, a dispersing agent, a UV absorber, a hindered amine light stabilizer (HALS), an organic clay derivative, fumed silica, a pigment, a biocide, or combinations thereof.

Illustrative embodiment 28 is a substrate comprising the coating composition of any preceding illustrative embodiment.

Illustrative embodiment 29 is the substrate of any preceding or subsequent illustrative embodiment, wherein the coated substrate demonstrates a maximum average load force of 400 N when subjected to ICE ADHESION TEST.

Illustrative embodiment 30 is the substrate of any preceding or subsequent illustrative embodiment, wherein the coated substrate demonstrates a maximum barnacle adhesion force of 0.2 MPa when subjected to BARNACLE REMOVAL RELEASE TEST.

Illustrative embodiment 31 is the substrate of any preceding or subsequent illustrative embodiment, wherein the coating has a loss of less than 60 mg for abrasion resistance as measured by ASTM D4060-14.

Illustrative embodiment 32 is the substrate of any preceding or subsequent illustrative embodiment, wherein the coated substrate demonstrates a minimum average removal of at least 30% for C. lytica when subjected to MICROORGANISM REMOVAL TEST with a 20 psi water jet.

Illustrative embodiment 33 is the substrate of any preceding illustrative embodiment, wherein the coated substrate demonstrates a minimum average removal of at least 50% for N. incerta when subjected to MICROORGANISM REMOVAL TEST with a 20 psi water jet.

Illustrative embodiment 34 is an article comprising the substrate of any preceding illustrative embodiment.

Illustrative embodiment 35 is a method for coating a substrate comprising applying to at least a portion of the substrate the coating composition of any preceding illustrative embodiment.

Illustrative embodiment 36 is the method of any preceding or subsequent illustrative embodiment, wherein the substrate comprises metal, plastic, concrete, asphalt, wood, geotextile, a fiberglass composite, and/or carbon fiber composite.

Illustrative embodiment 37 is the method of any preceding or subsequent illustrative embodiment, wherein the metal substrate comprises iron, steel, steel alloys, galvanized metals, and/or aluminum.

Illustrative embodiment 38 is the method of any preceding or subsequent illustrative embodiment, wherein at least a portion of the substrate comprises a first coating and/or a primer.

Illustrative embodiment 39 is the method of any preceding or subsequent illustrative embodiment, further comprising preparing at least the portion of the substrate prior to applying the coating composition.

Illustrative embodiment 40 is the method of any preceding or subsequent illustrative embodiment, wherein preparing at least the portion of the substrate comprises grit blasting, sand blasting, priming, and/or electrocoating at least the portion of the substrate.

Illustrative embodiment 41 is the method of any preceding or subsequent illustrative embodiment, wherein preparing at least a portion of the substrate comprises applying a mold release agent to at least a portion of the substrate.

Illustrative embodiment 42 is the method of any preceding or subsequent illustrative embodiment, wherein applying the coating composition comprises extrusion and/or spraying.

Illustrative embodiment 43 is the method of any preceding or subsequent illustrative embodiment, wherein spraying comprises air purge spray, mechanical purge spray, atomized air spray, non-atomized air spray, atomized airless spray, or non-atomized airless spray.

Illustrative embodiment 44 is the method of any preceding or subsequent illustrative embodiment, wherein the coated substrate demonstrates a maximum average load force of 400 N when subjected to ICE ADHESION TEST.

Illustrative embodiment 45 is the method of any preceding or subsequent illustrative embodiment, wherein the coated substrate demonstrates a maximum barnacle adhesion force of 0.2 MPa when subjected to BARNACLE REMOVAL RELEASE TEST.

Illustrative embodiment 46 is the method of any preceding or subsequent illustrative embodiment, wherein the coating has a loss of less than 60 mg for abrasion resistance as measured by ASTM D4060-14.

Illustrative embodiment 47 is the method of any preceding or subsequent illustrative embodiment, wherein the coated substrate demonstrates a minimum average removal of at least 30% for C. lytica when subjected to MICROORGANISM REMOVAL TEST with a 20 psi water jet.

Illustrative embodiment 48 is the method of any preceding illustrative embodiment, wherein the coated substrate demonstrates a minimum average removal of at least 50% for N. incerta when subjected to MICROORGANISM REMOVAL TEST with a 20 psi water jet.

Whereas particular examples of this disclosure have been described above for purposes of illustration, it will be evident to those skilled in the art that numerous variations of the details of the present disclosure may be made without departing from what is defined in the appended claims.

That which is claimed:

1. A coating composition comprising:
a polyurea component comprising an isocyanate component, an amine-functional resin, and an aliphatic copolymer; and
a polysiloxane component.

2. The coating composition of claim 1, wherein an equivalent weight ratio of the isocyanate component to the amine-functional resin ranges from 1.01:1 to 1.4:1.

3. The coating composition of claim 1 or 2, wherein the amine-functional resin ranges from 16 to 43 wt. %.

4. The coating composition of claim 1, wherein the aliphatic copolymer component comprises a silicone copolymer.

5. The coating composition of claim 1, wherein the aliphatic copolymer component comprises a silicone polyether copolymer.

6. The coating composition of claim 1, wherein the isocyanate component comprises a prepolymer formed from isophorone diisocyanate and polyetherdiamine.

7. The coating composition of claim 1, wherein the amine-functional resin comprises a di-functional amine, a triamine, an aliphatic diamine chain extender, or combinations thereof.

8. The coating composition of claim 7, wherein the di-functional amine comprises an aspartic acid ester.

9. The coating composition of claim 7, wherein the triamine comprises polyetheramine.

10. The coating composition of claim 7, wherein the aliphatic diamine chain extender comprises an ethylcyanide.

11. The coating composition of claim 1, wherein the polysiloxane component comprises up to 60 wt. % based on total solid weight of the composition.

12. The coating composition of claim 1, wherein the polysiloxane component comprises an amine functional silicone, a silicone polyether copolymer, a phenyl silicone, or combinations thereof.

13. The coating composition of claim 1, wherein the polysiloxane component comprises a polydimethylsiloxane, phenylmethyl polysiloxane, polyphenylmethyldimethylsiloxane, or combinations thereof.

14-16. (canceled)

17. The coating composition of claim 3, wherein the amine-functional resin comprises:
8 to 25 wt. % of a di-functional amine;
5 to 15 wt. % of a triamine; and
3.6 to 12 wt. % of an aliphatic diamine chain extender.

18. The coating composition of claim 19, further comprising an additive in an amount up to 30 wt. %, wherein the additive comprises a wetting agent, a dispersing agent, a UV absorber, a hindered amine light stabilizer (HALS), an organic clay derivative, fumed silica, a pigment, a biocide, or combinations thereof.

19. A coating composition comprising:
a polyurea component comprising:
an isocyanate component,
8 to 25 wt. % of a di-functional amine;
5 to 15 wt. % of a triamine;
3.6 to 12 wt. % of an aliphatic diamine chain extender; and
an aliphatic copolymer; and
up to 60 wt. % of a polysiloxane component,
wherein an equivalent weight ratio of the isocyanate component to the total amount of di-functional amine, triamine, and aliphatic diamine chain extender ranges from 1.01:1 to 1.4:1.

20. A substrate comprising the coating composition of claim 1.

21. The substrate of claim 20, wherein the coated substrate demonstrates a maximum average load force of 400 N when subjected to ICE ADHESION TEST, a maximum barnacle adhesion force of 0.2 MPa when subjected to BARNACLE REMOVAL RELEASE TEST, a minimum average removal of at least 30% for C. lytica when subjected to MICROORGANISM REMOVAL TEST with a 20 psi water jet, a minimum average removal of at least 50% for N. incerta when subjected to MICROORGANISM REMOVAL TEST with a 20 psi water jet, and/or a maximum loss of 60 mg for abrasion resistance as measured by ASTM D4060-14.

22. An article comprising the substrate of claim 20.

23. A method for coating a substrate comprising applying to at least a portion of the substrate the coating composition according to claim 1.

24-30. (canceled)
